(19) United States
(12) Patent Application Publication
(10) Pub. No.: US 2024/0183788 A1
(43) Pub. Date: Jun. 6, 2024

(54) METHOD AND APPARATUS FOR INSPECTING LACQUERED SURFACES WITH EFFECT PIGMENTS

(71) Applicant: BYK-GARDNER GMBH, Geretsried (DE)

(72) Inventor: Uwe SPERLING, Geretsried (DE)

(21) Appl. No.: 18/568,994

(22) PCT Filed: May 24, 2022
(86) PCT No.: PCT/EP2022/064130

§ 371 Date: Dec. 11, 2023

(30) Foreign Application Priority Data
Jun. 17, 2021 (DE) 10 2021 115 728.5

(51) Int. Cl. G01N 21/84; G01N 21/29; G01N 21/47; G01N 21/93

(52) U.S. Cl. CPC G01N 21/8422; G01N 21/29; G01N 21/4738; G01N 21/93; G01N 2021/4783; G01N 2021/8427

(57) ABSTRACT

A method for inspecting lacquered surfaces is provided, wherein radiation being irradiated by a first radiation device onto a surface to be inspected at a first predetermined irradiation angle, and a color image recording device recording a spatially resolved image of the surface irradiated by the irradiation direction at a first observation angle, this image recording device having a first predetermined sensitivity dependent on a wavelength of the radiation impinging on the image recording device, wherein an image evaluation device carries out a section-by-section and desirably pixel-by-pixel evaluation of the image recorded by the image recording device.

### CROSS-REFERENCE TO RELATED APPLICATIONS

This application claims priority to PCT Application No. PCT/EP2022/064130, having a filing date of May 24, 2022, based on German Application No. 10 2021 115 728.5, having a filing date of Jun. 17, 2021, the entire contents both of which are hereby incorporated by reference.

### FIELD OF TECHNOLOGY

The following relates to a method and an apparatus for inspecting lacquered surfaces, and in particular such surfaces which have a paint mixture of absorption pigments and effect pigments. Such lacquer layers have been known in the conventional art for a long time. Various methods and apparatuses are also known from the conventional art for inspecting and/or analyzing such surfaces.

### BACKGROUND

It is known that the spectral characteristic of an illuminated measuring spot is recorded with a dispersive element (such as a grating, prism or filter) and this is compared with a standard, for example. It is also known that the measurement results of such measurement methods often differ greatly from each other, on the one hand because the differences between the image recording characteristics of a camera on the one hand and the human eye on the other hand are only insufficiently taken into account, and on the other hand because optical filter devices also differ greatly.

A procedure is therefore sought to enable the most uniform or characteristic evaluation possible of images of such surfaces.

In a method for inspecting lacquered surfaces and in particular surfaces which have one or more layers with absorption pigments and effect pigments, a surface to be inspected is illuminated by a first radiation and/or illumination device at a predetermined angle of incidence and/or radiation is irradiated onto this surface and a color image recording device records a spatially resolved image of the surface irradiated and/or illuminated by the direction of incidence at a first angle of observation. This image recording device has a first predetermined sensitivity depending on the wavelength of the radiation incident on the image recording device.

According to embodiments of the invention, an image evaluation device performs a section-by-section and pixel-by-pixel evaluation of the image recorded by the image recording device.

In an embodiment, the surface is the exterior surface of a motor vehicle and in particular a lacquered exterior surface of a motor vehicle and in particular a passenger car. However, other surfaces could also be examined, such as the surfaces of pieces of furniture.

In an embodiment, results of this evaluation are used or taken into account for (future) measurements by the apparatus used in the evaluation. In an embodiment, the evaluation determines and/or generates a “filter device” and in particular a software filter device, which is taken into account and/or used for (future) measurements.

For example, as mentioned above, the evaluation related to the image recording device can be carried out pixel by pixel. Through this evaluation, at least one calibration value can be assigned to each pixel or each range of pixels for future measurements. This calibration value is determined in the course of the evaluation for each individual pixel. For future measurements with the apparatus, the calibration value determined within the scope of the evaluation (in particular for each pixel) can also be taken into account when outputting measurement results for each individual pixel of the image recording device.

Methods are known from the applicant's internal conventional art in which an optical filter device is arranged between the surface and the image recording device. This is also intended to compensate for different evaluation characteristics of the human eye on the one hand and a camera on the other. However, it has been shown that such filter devices themselves have a high dispersion (with regard to their characteristics) and therefore lead to different evaluations. In addition, corresponding lighting devices such as LEDs are also subject to strong scattering. This means that even two LEDs from the same production that should be identical in themselves differ in terms of their beam characteristics. Furthermore, there is also a high diversity of RGB filters from camera to camera and even within a single camera.

For this reason, there is a need for a specially adapted filter that takes into account changes in the camera or light source characteristics (if, for example, the camera chip or LED has to be replaced). In addition, the state of the art also allows for only a standard light type. By introducing a specially matched filter, different standard light types can be taken into account mathematically.

Embodiments of the invention thus propose a section-by-section and in particular pixel-by-pixel evaluation of the image, in particular also as a function of the wavelength, in order to be able to adapt to the respective conditions, i.e., to a specific radiation characteristic of the illumination device and also to an image recording device or its characteristic. It is possible that the evaluation is repeated, for example, carried out at predetermined times. The result and/or the measured value(s) of the evaluation are stored.

The image recording device, as known per se from the conventional art, comprises an image recording element with a plurality of image pixels, each of which is suitable for detecting the radiation impinging thereon. For example, the image recording element could comprise a CCD chip. The evaluation is performed for at least some of the pixels, for at least 30%, for at least 50%, for at least 60% or for at least 70% of the pixels. The evaluation can be carried out for each individual one of these pixels, but it would also be conceivable that several pixels are combined for an evaluation and thus the resolution of the evaluation is reduced to a certain extent.

For example, such image evaluation could be carried out at predetermined time intervals.

In a method, a weighting of the measurement signals of individual pixels is carried out taking into account the pixel-by-pixel evaluation. In this way, a software filter device can be used or created, which in particular also influences the image evaluation for later images.

In a method, the evaluation is performed as a function of the wavelength of the radiation incident on the image recording device. This means that a wavelength-dependent evaluation of a sensitivity of the image recording device and in particular also of the sensitivity of each individual pixel is recorded as a function of the wavelength.

In an embodiment, the evaluation is therefore carried out as a function of a wavelength-dependent (and in particular also pixel by pixel) sensitivity of the image recording device. In an embodiment, an individual evaluation is carried out for each individual image recording device. In an embodiment, this evaluation is also carried out pixel by pixel.

In an embodiment, a wavelength-dependent sensitivity of the image recording device is determined. In particular, the sensitivity can be determined pixel by pixel (in particular wavelength-dependent) or the wavelength-dependent sensitivity can be determined for each individual pixel.

However, it would also be possible for the evaluation to take place over several pixels, for example, to be averaged over several pixels of the same intensity.

In a further method, the image recording device and in particular a color image camera is also used to evaluate and/or assess the effect pigments.

In a further method, the influence of effect pigments on the image recording and/or the integral color measurement is taken into account and/or eliminated in particular within the scope of the image evaluation.

In the state of the conventional art, there is the problem that integral color measurements can be faulty, since it is not possible to distinguish whether measurement results that occur are caused by the color of a flake or effect pigment or have another cause. The proposed method allows such a distinction. More precisely, a spatially resolved color measurement is carried out for this purpose.

With an integral color measurement, errors can occur in particular if the effect pigments themselves produce colored effects, in particular in a different color than the colorfulness caused by the absorption effects.

For example, a solid color with only one absorption pigment (e.g., solid red) and the same absorption pigment (e.g., red) with the addition of colored effect pigments would result in different color values XYZ being measured in the integral color measurement.

Multi-angle color measurement devices known from the state of the art enabled an integral, averaged, non-spatially resolved color measurement over the entire illuminated measuring spot at several angles. In the history of device developments, the first devices were without a camera, later camera devices were added. The camera measurement was used here exclusively to evaluate the ‘glitter’ directed light (direct sunlight) and the ‘graininess’ (diffuse lighting, overcast sky) and is an additional piece of information independent of the color measurement for the characterization of effect pigment lacquers.

The use of cameras in multi-angle color measuring devices when measuring plain lacquers (which only contain absorption pigments) is unnecessary and only makes sense for effect paints that contain a mixture of absorption pigments and one (or more) types of effect pigments.

In embodiments, the method proposed here eliminates the influence of the effect pigment measurement on the absorption pigment measurement and would result in both measurements obtaining the same values in the above example.

In a method, the influence of the effect pigment measurement on the measurement of the absorbing pigment(s) is reduced and/or eliminated.

In an embodiment, it is proposed within the scope of the invention that the image recording device and, in particular, a color image camera is also used for evaluating and/or assessing the effect pigments (and, in particular, their color properties).

Furthermore, however, information about the colorfulness and/or color distribution of the areas of the image which are due to and/or contain effect pigments are obtained. Thus, those advantages that are achieved by the use of a color imaging camera can still be maintained.

In an embodiment, the wavelength-dependent sensitivity is determined by a spectrometer and/or a monochromator and/or the evaluation of the image recorded by the image recording device is carried out by a spectrometer and/or a monochromator. Several procedures are conceivable for determining the spectral sensitivity of an image recording device and in particular of each individual pixel.

For example, with the following equations, it would be possible to obtain the characteristic curves of the individual channels of an RGB CMOS/CCD camera chip, which has a Bayer pattern, as sums over a plurality of wavelengths.

p=s(λ₁)E(λ₁)+ . . . s(λₙ)E(λₙ)

pⱼ=sᵢE_{i,j}|i,j=1 . . . n

pⱼE_{i,j}⁻¹=sᵢ

p_{j,k}E_{i,j}⁻¹=s_{i,k}|k=1 . . . number of pixel

Here p denotes the measured value (red, green, blue). s(lᵢ)=sᵢ denotes the spectral sensitivity of the pixel/filter combination. E_{i,j} denotes the calibration tile with known remission spectrum number j at wavelength lᵢ.

In addition, it would also be possible to perform a multiple linear regression. This can be done using the following equations:

$${p}_{j} = s ( {λ}_{1} ) {E}_{j} ( {λ}_{1} ) + ⋯ + s ( {λ}_{n} ) {E}_{j} ( {λ}_{n} ) i = 1 .. n , j = 1 .. m \vert m > n \\ {s}_{i , k} = ( \begin{matrix}{s}_{1 , k} \\ ⋮ \\ {s}_{n , k}\end{matrix} ) = {( {E}^{T} E )}^{- 1} {E}^{T} ( \begin{matrix}{p}_{1 , k} \\ ⋮ \\ {p}_{m , k}\end{matrix} ) k = 1 .. number of pixel$$

Within the scope of embodiments of the present invention, it is proposed to determine the spectral sensitivity for each pixel by a monochromator and/or a (in particular absolutely calibrated) spectrometer. Based on these recorded spectral sensitivities, deviations can be determined in each case and these deviations can be taken into account in the subsequent image evaluation in order to record and/or output a colorimetrically correct image of the individual pixels.

In a method, to determine the wavelength-dependent sensitivity of the imaging recording device, radiation is irradiated onto the surface at a predetermined angle onto a set of reference surfaces with known remission and the imaging recording device records an image of this surface. In an embodiment this angle is greater than 20° with respect to a perpendicular direction, greater than 30°, greater than 40°, greater than 50° or greater than 60°.

Additionally, or alternatively, it would be possible for the surface to be illuminated with a particularly monochromatic light from a further, in particular external, auxiliary light source. These auxiliary light sources can be, for example, monochromatic LEDs or white light filtered by a plurality of band-pass filters. Here, too, the illumination angle is greater than 20° with respect to a perpendicular direction, greater than 30°, greater than 40°, greater than 50° or greater than 60°.

The reason for taking the images with illumination at a very large angle or very flat illumination with respect to the direction of extension of the surface to be observed is that these surfaces behave in the least distorted manner defined by the effect pigments used in the coating under these illuminations. Silver metallic coatings, for example, consist only of aluminum flakes or partly of flakes with a certain amount of TIO2.

In this case, a grey neutral light direction spectrum can be expected under a flat irradiation or illumination angle. Further surfaces have chromatic metallic coatings with aluminum and usually have only a small number of effect pigments. In this case, only a few of these flakes are visible at flat illumination angles. So-called xyrallic or MICA coatings have even fewer effect pigments, i.e., in this case none of these flakes are visible at the angles mentioned. In an embodiment, the image evaluation is performed separately and/or independently for the absorption pigments and for the effect pigments (flakes).

In an embodiment, in the case of the absorption pigment recipe, a pixel number is recorded and/or stored together with the intensity value assigned to it or determined (output by the pixel in question). In a further step, a histogram may be recorded, and a maximum value of the respective frequency determined. In a further step, an average value XYZ is recorded for a statistically defined number of pixels.

For the evaluation of the effect pigments, flakes are selected which are separated from each other and which reach or cover all three filters (i.e., whose radiation characteristics or radiation maxima lie in the respective wavelength ranges of the relevant filter devices of the image recording device) and only for these flakes the product XYZ is determined. In an embodiment, no demosaicing is used in this case. In an embodiment, at least two images are taken with a certain exposure time.

In an embodiment, the color effect of the absorption pigment is assessed with an image taken at a first predetermined angle, in particular an angle remote from the gloss, at which the falsification of the color measurement by the effect pigment is negligible to a good approximation. An angle remote from the gloss is understood to be an angle that deviates from the direction of reflection by at least 30°.

The sparkles caused by the effect pigments are identified with a camera image taken at a second, in particular near-gloss angle. A near-gloss angle is understood to be an angle that deviates from the direction of reflection by no more than 25°, no more than 20°, or no more than 15°.

Due to the near-gloss angle, the effect pigments can be identified in the camera image as areas of high intensity (lying above a certain threshold) , i.e., it is known with pixel precision whether it is an area on the sample with absorption pigment or effect pigment.

In a further advantageous method, the evaluation and/or measurement with the apparatus takes into account a sensitivity of the human eye that is dependent on a wavelength of the radiation striking the human eye.

In a further method, data determined in the course of the evaluation are taken into account in order to generate a filter device, in particular a software filter device, for subsequent measurements with the apparatus that also performs the evaluation, which calibrates the measured values recorded or determined by the image recording device. In an embodiment, the recorded image is calibrated pixel by pixel and/or the measured values output by the individual pixels are calibrated individually.

Thereby it is possible that by one and in particular the filter device differences between this first sensitivity (of the image recording device) and a second sensitivity (of the human eye) are at least partially compensated.

In a further method, radiation is irradiated onto the surface by a second radiation device and a second predetermined irradiation angle, and the image recording device records an image of the surface irradiated by the second radiation device. Alternatively, a second observation device may also be used. In addition, a third radiation device is also provided, which irradiates radiation onto the surface to be examined.

In an embodiment, the illumination takes place at different angles. In a further method, at least one radiation device radiates directional or diffuse radiation onto the surface.

In a further method, a data reduction of the data recorded during the evaluation is carried out, wherein this data reduction differs with regard to the absorption pigments and the effect pigments. In this case, data reduction can be carried out, for example, in such a way that during the evaluation of the wavelength-dependent sensitivity of a pixel or during the evaluation of the incident radiation, only those wavelength ranges are examined in which a certain intensity (which is determined in particular from the course of the spectrum), for example a (local) intensity maximum, occurs. In this way, an intensity limit can be determined which enables the detection of areas without flares. In this way, those areas of an image are identified which contain images of flakes or those areas which are free of flakes.

When observing surfaces, the problem arises that commercially available image recording devices such as RGB cameras have a certain wavelength-dependent sensitivity, which deviates from the wavelength-dependent sensitivity of the human eye. Accordingly, the task is to enable the most realistic possible image recording of the irradiated surface (or the most realistic possible evaluation of this image recording).

Embodiments of the invention therefore propose to achieve, by a filtering device (which is in particular a software filtering device and in particular such a filtering device which takes into account the data recorded in the course of the evaluation), an at least partial adaptation of the image recording device to the human eye.

The CIE Standard Valence System or CIE Standard Color System is a color system defined by the International Commission on Illumination (CIE—Commission internationale de l'éclairage) to establish a relationship between human color perception (color) and the physical causes of the color stimulus (color valence). It captures the totality of perceivable colors. Using the color space coordinates, the term Yxy color space or CIE-Yxy is also commonly used, as well as tristimulus color space, primarily in the English-speaking world.

Especially in the English-speaking world, the three basic values X, Y and Z are called tristimulus. In this meaning, they are the three parts of the (for this purpose) defined normalized basic colors. Each color can be identified with such a triple of numbers. Accordingly, the term tristimulus system is commonly used for the CIE standard system. The curves are also called tristimulus curves.

In one embodiment, an image is therefore recorded, and the individual pixels are evaluated, in particular with regard to colors, wherein a wavelength-dependent evaluation and/or weighting is carried out.

In a method, the evaluation is performed in such a way that it at least temporarily compensates for the wavelength-dependent differences between the first sensitivity (of the imaging recording device) and the second sensitivity (of the human eye).

In this context, an emission spectrum L(λ) of the radiation device, an intensity curve I(λ) of a standard light, at least one tristimulus function X(λ), in particular of the human eye, and/or a value and/or curve characteristic of a filter characteristic F(λ) of the image recording device are taken into account when selecting the filter device.

In an embodiment, the wavelength-dependent transmission T(λ) of a filter device results in:

T(λ)=X(λ)/(I(λ)·L(λ)·F(λ))

Here, I(λ) denotes the wavelength-dependent characteristic of the type of light, for example D65, L(λ) denotes the wavelength-dependent characteristic of the light source, F(λ) denotes the wavelength-dependent characteristic of the observation device (in particular a RGB filter) and in particular its filter) and X(λ) denotes the wavelength-dependent light sensitivity of the eye (tristimulus functions).

In an embodiment, the wavelength-dependent characteristic of the observation device and the wavelength-dependent light sensitivity of the eye have different functions over at least two, 3 predetermined wavelength ranges.

In an embodiment, the first wavelength range extends from 300 nm-600 nm, from 350 nm-550 nm and preferably from 400 nm-500 nm. Furthermore, the second wavelength range extends from 400 nm-700 nm, 450 nm-650 nm, and 500 nm-650 nm and 530 nm-600 nm. Furthermore, the third wavelength range extends from 500 nm-900 nm, from 550 nm-800 nm or from 600 nm-700 nm.

The entire perceptual range of the human eye is covered.

In a further method, radiation is irradiated onto the surface at a second predetermined irradiation angle by a second radiation device and the image recording device records an image of the surface irradiated by the second radiation device.

In an embodiment, the first and second radiation devices irradiate the surface at different times or periods of time. Alternatively, or additionally, it would also be conceivable for a second image recording device to observe the surface at a second observation angle.

By irradiating by two or more radiation devices, it is also possible to detect effects that result from differently aligned effect pigments.

In a further method, a third radiation device is also provided, which radiates radiation onto the surface at a third angle of incidence.

In a further method, the angle of observation with respect to a direction perpendicular to the surface is less than 10°, less than 5°, or less than 3°.

In a further method, the first angle of incidence in relation to a direction perpendicular to the surface is between 70° and 20°, between 60° and 30°, or between 50° and 40°.

In an embodiment, a second angle of incidence of the second radiation device with respect to a direction perpendicular to the surface is between 85° and 50°, between 85° and 60°, or between 85° and 70°.

In an embodiment, at least one radiation device directs directional or diffuse radiation onto the surface. By using diffuse radiation, solar radiation can be simulated under a cloudy sky, and by using directed radiation, solar radiation can be simulated under a cloudless sky.

In an embodiment, at least one further radiation device and all radiation devices direct diffuse or, in particular, directional radiation onto the surface.

Embodiments of the present invention are further directed to an apparatus for inspecting lacquered surfaces comprising a mixture of absorption pigments and at least one further effect pigment, comprising a first radiation device which irradiates radiation onto a surface to be inspected at a first predetermined irradiation angle and a color image recording device which records a spatially resolved image of the surface irradiated by the irradiation direction at a first observation angle, which takes a spatially resolved image of the surface irradiated by the irradiation direction at a first observation angle, wherein this image recording device comprising a first predetermined sensitivity dependent on a wavelength of the radiation impinging on the image recording device.

According to embodiments of the invention, the apparatus has an image recording device which performs a section-by-section and pixel-by-pixel evaluation of the image recorded by the image recording device.

In an embodiment, the apparatus has a memory device in which the measured values determined by the evaluation device are stored. In an embodiment, the memory device allows these measured values to be stored pixel by pixel.

In a further embodiment, the apparatus has a filter device and, in particular, a software filter device which calibrates further images recorded by the image recording device and, in particular, calibrates them taking into account the values determined by the evaluation device and/or which is suitable and intended for this purpose.

In an embodiment, the filtering device (and/or a processor device implementing this filtering device) is suitable and intended to calibrate recorded images pixel by pixel.

In an embodiment, this filter device is changeable, i.e., in particular the way in which this filter device affects the images output by the image recording device is changeable. This means that by modifying the (software) filter device, it is also possible to change the images output by the image recording device and/or measured values output by the apparatus in general.

In an embodiment, the apparatus can be operated in a calibration mode in which an evaluation of the images recorded by the image recording device and a determination and/or modification of the software filter device takes place. In an embodiment, the apparatus can also be operated in a working mode in which, in particular, a software filter device determined in the calibration mode is applied.

In an embodiment, the apparatus is a multi-angle measuring device, i.e., it is suitable and intended for inspecting the surface from several (illumination and/or irradiation) angles.

In an embodiment, the apparatus is “backwards” compatible with apparatuses using a black and white image recording device. In particular, measurement results obtained with embodiments of the present invention can be compared with measurement results obtained with black and white imaging recording devices.

However, embodiments of the invention can also be used for plain lacquers (without effect pigments) of motor vehicles (or of other surfaces).

In an embodiment, the radiation device and the observation device as well as, if applicable, the filter device are arranged in a common housing. In an embodiment, an inner wall of this housing is light-absorbing. In a further embodiment, the housing has essentially only one opening through which the surface is observed. In a further embodiment, the apparatus is portable.

In a further embodiment, the image recording device has filters and in particular RGB filters. In an embodiment, the radiation device emits standard light and in particular D65 standard light. Standard light is the term used to describe the standardized spectral radiation distribution curves of characteristic radiators. D65 standard light is a radiation distribution with a color temperature of 6504 Kelvin (which corresponds approximately to a grey sky).

In an embodiment, a distance between the surface and the radiation device is between 3 cm and 30 cm, between 4 cm and 20 cm, or between 4 cm and 10 cm.

In an embodiment, the radiation device is suitable and intended to emit radiation of different wavelengths. A filter device such as a filter wheel with different filters can be provided, which only allow light of certain wavelengths to pass.

In a further embodiment, the first radiation device comprises a light emitting diode (LED) and in particular a tri-phosphor LED. In an embodiment, the apparatus also has further radiation devices, as mentioned above. These also have light-emitting diodes and in particular tri-phosphor LEDs.

In a further embodiment, the apparatus has at least a second radiation device and/or a second sensor device. This second sensor device can also be designed as an image recording device, but it is also conceivable that this sensor device is a sensor device which determines an intensity of the radiation incident on it.

In a further embodiment, the apparatus has at least three radiation devices (or illumination devices), which illuminate the surface at at least three different angles.

In a further embodiment, the filter device performs a pixel-by-pixel calibration of the values or signals output from the individual pixels of the image recording device.

### BRIEF DESCRIPTION

Some of the embodiments will be described in detail, with references to the following Figures, wherein like designations denote like members, wherein:

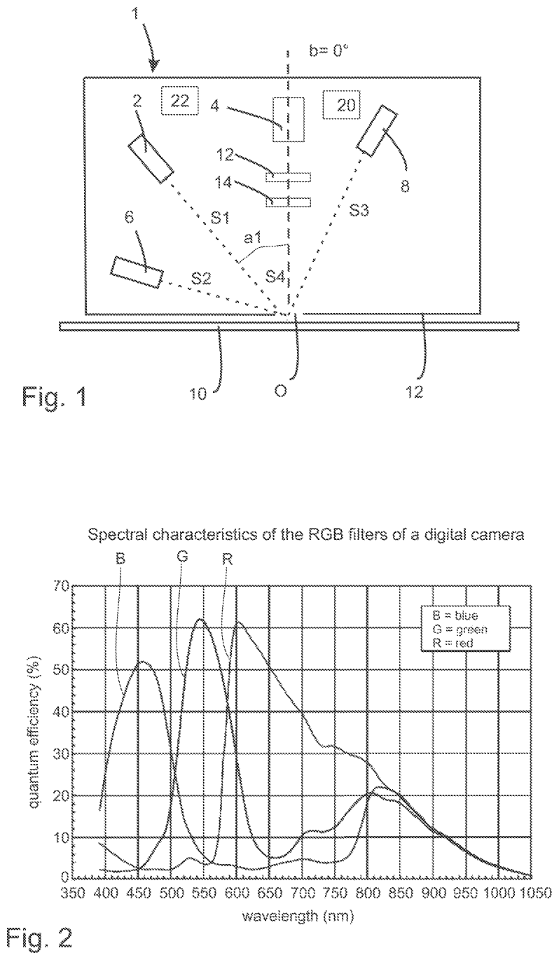

FIG. 1 shows a schematic representation of an apparatus according to embodiments of the invention;

FIG. 2 shows a representation of a spectral characteristic of the RGB filters of a digital camera;

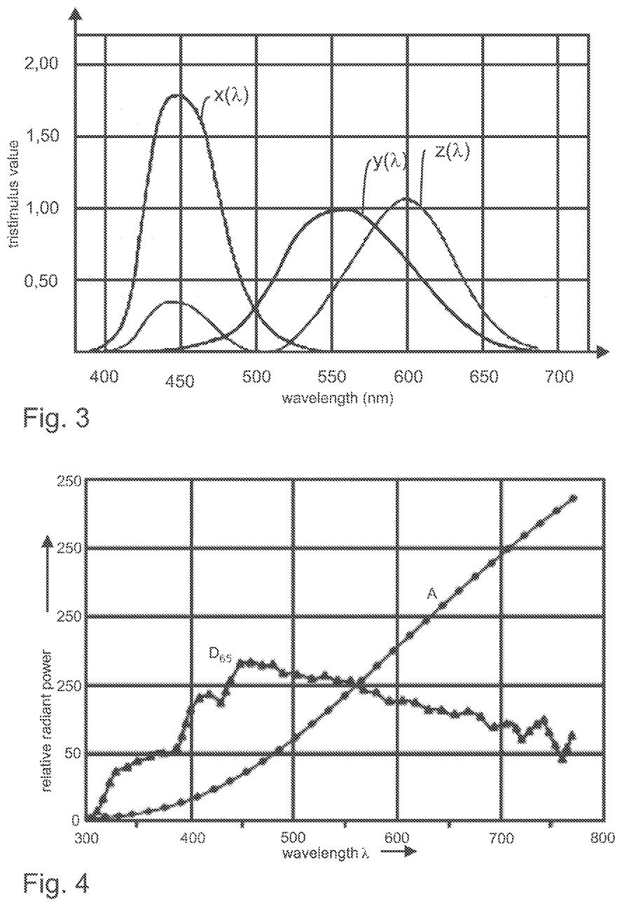

FIG. 3 shows sensitivity curves of the 3 color receptors X (red), Y (green) and Z (blue);

FIG. 4 shows a representation of the radiant power of the standard light type D65;

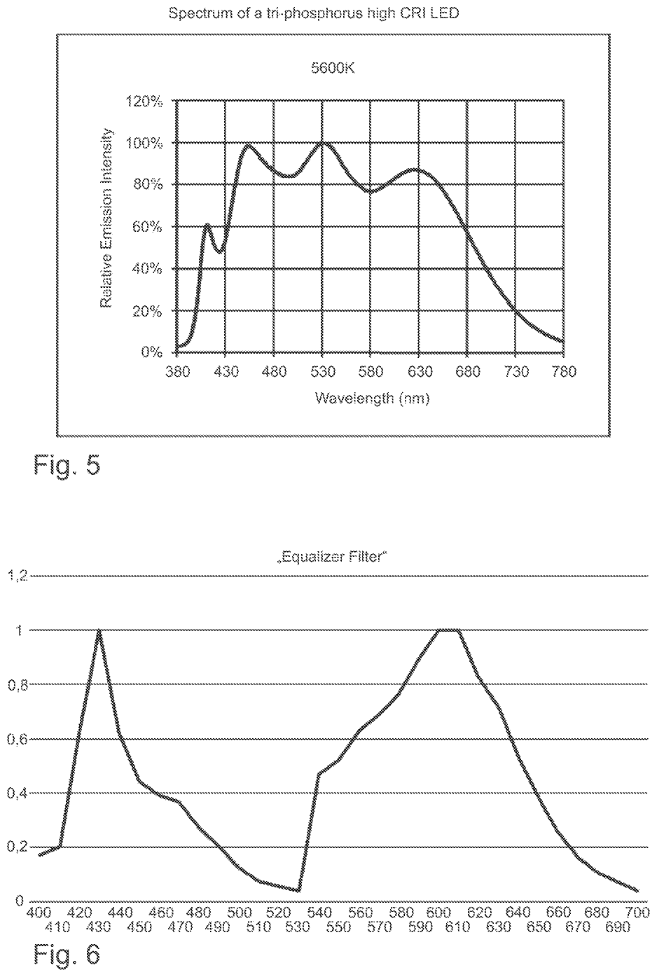

FIG. 5 shows an emission spectrum of an LED;

FIG. 6 shows a transmission behavior of a filter device;

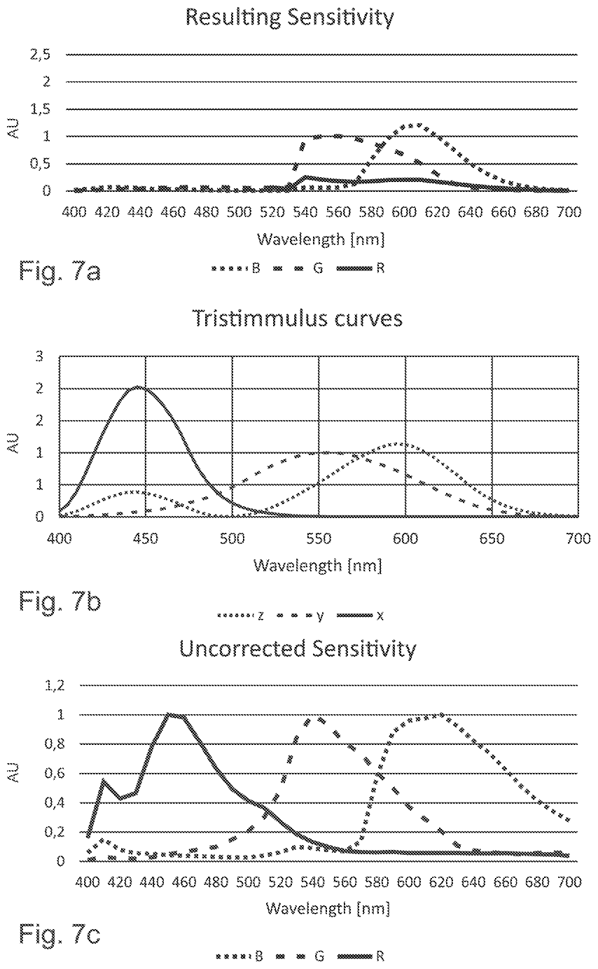

FIG. 7a shows a comparison of the resulting sensitivities;

FIG. 7b shows a comparison of the resulting sensitivities;

FIG. 7c shows a comparison of the resulting sensitivities;

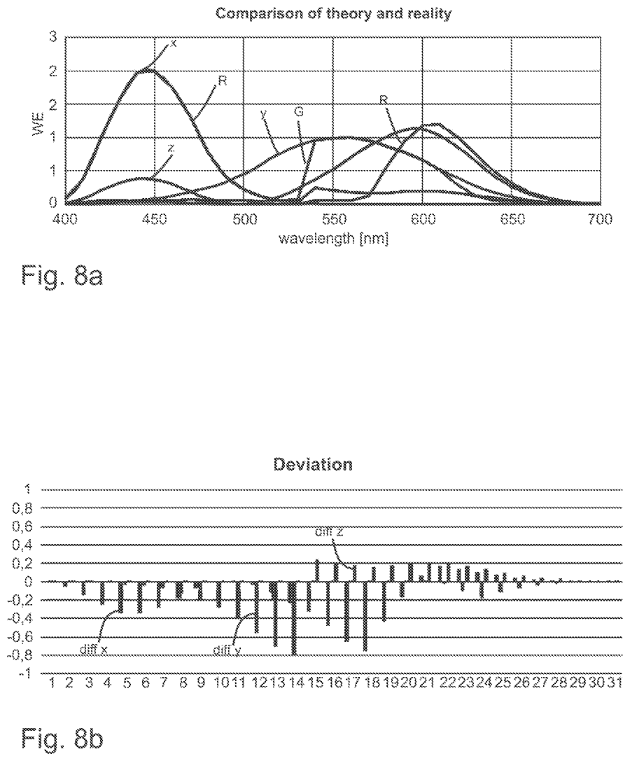

FIG. 8a shows a comparison of theoretical and actual intensity curves;

FIG. 8b shows a representation of deviations between a theoretical and an actual course; and

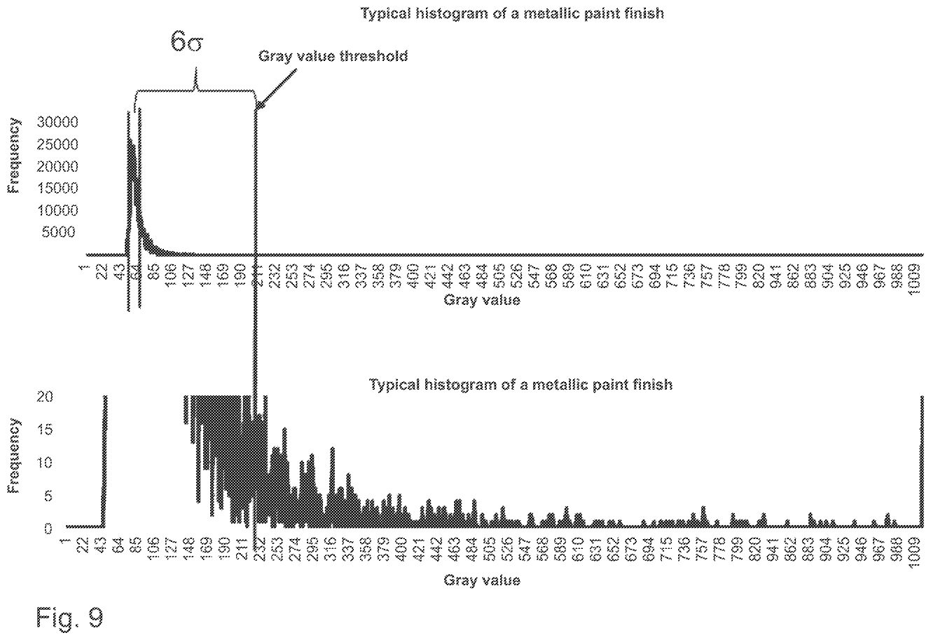

FIG. 9 shows a representation of a histogram for a metallic lacquer.

### DETAILED DESCRIPTION

FIG. 1 shows a schematic representation of an apparatus 1 for inspecting surfaces 10. This apparatus has a first radiation device 2 or illumination device 2 which radiates light onto the surface 10, beam S2.

The reference sign 4 indicates an image recording device which records at least one spatially resolved image of the surface illuminated by the first radiation device (beam path S4). The reference sign O indicates an opening in the housing 12 through which the surface 10 is irradiated and through which the image recording device 4 observes the surface. The image recording device records the images at an observation angle of 0°, i.e., it is arranged vertically above the surface 10.

The reference sign 12 indicates an optionally present filter device which is arranged in the beam path S4 between the surface 10 and the image recording device and through which the image recording device records an image of the surface 10.

The reference sign 14 indicates an optionally present lens device which serves to collimate the light reflected and/or scattered by the surface 10 so that it also strikes the filter device in a collimated manner and also perpendicularly to the filter device.

The reference sign 20 indicates an evaluation device which evaluates the images recorded by the image recording device 4. The evaluation device can output data that are characteristic of the physical properties of the surface.

The reference sign 22 identifies a processor device which calibrates and/or modifies the images taken by the image recording device in a working mode of the apparatus and in particular calibrates and/or modifies them pixel by pixel taking into account the data determined by the evaluation device. In an embodiment, therefore, this processor device determines the above-mentioned software filter device.

The reference sign 6 indicates a second radiation device which also radiates radiation and in particular light onto the surface (but at a different angle of incidence or along the beam path S2). This radiation device in particular can be used to evaluate the recorded images.

The reference sign 8 indicates a third radiation device which also radiates radiation and in particular light along a beam path S3 onto the surface 10.

In an embodiment, a control device (not shown) is provided which activates the radiation devices 2, 6 and 8 with a time delay.

FIG. 2 shows a characteristic of an image recording device depending on the wavelength of the incident radiation. More precisely, the sensitivity of the RGB filters of this image recording device or camera is shown.

Three curves R, G, B are shown, which refer to the “red” , “green” and “blue” components. The quantum efficiency in % is plotted on the coordinate and the wavelength of the incident light on the ordinate.

It can be seen that the quantum efficiency of the camera as a whole first increases in the wavelength range between 400 nm and 800 nm and then decreases again. In this way, the image recording device has its own characteristic of image reproduction or image recording.

FIG. 3 shows a representation of the tristimulus functions of the human eye. Here, too, three curves x(λ), y(λ) and z(λ) are shown, wherein the wavelength in nm is recorded on the ordinate and the tristimulus value on the coordinate.

It can be seen by comparing the illustration shown in FIGS. 2 and 3 that the wavelength-dependent sensitivity curve of the image recording device and the human eye differ considerably. These differences are to be at least partially compensated for by embodiments of the invention.

FIG. 4 shows an illustration of the intensity curve of a D65 standard light source in a range between 300 nm and 800 nm. This type of light is approximated to the curve for daylight and cloudy skies. The second curve A shows the course of a conventional light bulb.

The standard light type D represents the daylight spectrum and is therefore of particular interest for numerous industrial areas. The light type D65 derives its name from the color temperature of 6,504 Kelvin (K). D65 is used in the chemical and pharmaceutical industries, in paint production, in the ceramics, fabric, paper and automotive industries.

The standard light type D65 has a high blue component with which fluorescent colors can be seen.

D65 is used as an evaluation light source. The spectral distribution of D65 light sources is defined in DIN 5033 and lies between wavelengths of 300 nm and 780 nm, thus between ultraviolet and red.

FIG. 5 shows an emission spectrum of a light source used in the context of embodiments of the invention, namely a tri-phosphor high CRI LED. It can be seen that this light source essentially radiates between 400 and 800 nm. The color temperature here is 5600 K. This radiation characteristic is also taken into account in the design of the filter device.

The abbreviation CRI stands for color rendering index. The color rendering index is a quantitative measure of a light source and describes the ability to render colors of objects compared to an ideal or natural light source. The term CRI is often used on commercial lighting products. Properly defined, it should be called Ra—general color rendering index—or Ri—specific color rendering index—according to the test color samples being evaluated.

The CRI is calculated by comparing the color rendering of the test light source with that of a defined light source. For test light sources below 5000 K, a blackbody radiator is used as a defined comparison source. Daylight (D-lamps) is used for comparison for test light sources above 5000 K. The calculation of Ri and Ra is explained in detail in the CIE technical report 13.3-1995. The test method uses a set of eight Ra or 14 Ri CIE-1974 color samples from an early edition of the Munsell color system. The first eight samples are moderately saturated, comprising the hue circle and have approximately equal brightness. The remaining six samples provide additional information about the color rendering properties of the light source.

FIG. 6 shows a transmission curve of a filter device adapted for embodiments of the present invention, as calculated from the data described above and the equation shown above. Based on this data, a filter device is manufactured which shows approximately the transmission behavior shown in FIG. 6. In the manufacture of filter devices, there are several methods for achieving a desired transmission curve, which have been explained above.

FIGS. 7a-7c show three representations of gradients (plotted in arbitrary units on the coordinate) . FIG. 7b again shows the course of the human eye, which is also shown in FIG. 3. FIG. 7c shows the course that results from an image recording device without the filter device proposed in accordance with embodiments of the invention. FIG. 7a shows a sensitivity or a course which results when the filter device is used. It can be seen that the curve shown in FIG. 7a is much closer to the “natural” curve shown in FIG. 7b than the curve shown in FIG. 7c.

FIG. 8a shows a diagram illustrating the method according to embodiments of the invention. A comparison between the curves shown in FIGS. 7b and 7c is shown in more detail. It can be seen that these curves are close together in some wavelength ranges but differ considerably in other wavelength ranges. Shown are the tristimulus curves X, Y, Z and on the other hand the resulting sensitivity curves B, G, R.

FIG. 8b shows a representation of the percentage deviations diff x, diff y, diff z of the curves from each other. Here, too, it can be seen that there are high deviations in some areas and only small deviations in others.

As mentioned above, the measured spectrum is recorded under a very flat angle of incidence, as in this case the influence of the individual flakes is very small.

The values for X, Y and Z can be determined using the following equations:

$${X}_{n , m} = {kR}_{n , m} \frac{{\sum }_{i = 400}^{700} s ( {λ}_{i} ) I ( {λ}_{i} ) \overline{x} ( {λ}_{i} )}{{\sum }_{i = 400}^{700} s ( {λ}_{i} ) I ( {λ}_{i} ) \overline{x} ( {λ}_{i} ) {C}_{n , m} ( {λ}_{i} )} \\ {Y}_{n , m} = {kG}_{n , m} \frac{{\sum }_{i = 400}^{700} s ( {λ}_{i} ) I ( {λ}_{i} ) \overline{y} ( {λ}_{i} )}{{\sum }_{i = 400}^{700} s ( {λ}_{i} ) \overline{I ( {λ}_{i} ) y} ( {λ}_{i} ) {C}_{n , m} ( {λ}_{i} )} \\ {Z}_{n , m} = {kB}_{n , m} \frac{{\sum }_{i = 400}^{700} s ( {λ}_{i} ) I ( {λ}_{i} ) \overline{z} ( {λ}_{i} )}{{\sum }_{i = 400}^{700} s ( {λ}_{i} ) I ( {λ}_{i} ) \overline{z} ( {λ}_{i} ) {C}_{n , m} ( {λ}_{i} )}$$

The following applies for k:

$$k = \frac{100}{{\sum }_{400}^{700} \frac{I ( λ )}{L ( λ )} \overline{x} ( λ )}$$

I (1) denotes the wavelength-dependent relative intensity of a standard light type. L (1) denotes the wavelength-dependent intensity of the radiation device.

FIG. 9 shows an illustration of data reduction by histogram calculation from the 2D image data. A typical histogram of a metallic coating (containing absorption and effect pigment) is shown. One can see a strong peak with a local maximum at an intensity value range between grey values of approx. 30 to 100, which can be assigned to the image pixels of the absorption pigments. Above a certain grey value threshold, which is a certain distance from the maximum of the absorption pigment peak, the histogram channels only contain pixels that can be assigned to the effect pigments. For data reduction, it is possible that with regard to the evaluation of the influence of the effect pigments, only the area below the grey value threshold is used.

In a further method step, the area of this maximum is selected for the evaluation of the absorption pigments and the value L*a*b is calculated and averaged in this area for a sufficient number of pixels. By this procedure, as mentioned above, areas of the image that reproduce flakes and areas that do not reproduce flakes can be identified.

For the evaluation of the flakes or the layer containing the flakes, separate flakes are desirably selected, as mentioned above. For example, a certain area of pixels can be assigned to a flake.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for inspecting lacquered surfaces which comprise one or more layers with absorption pigments and/or effect pigments, wherein radiation is irradiated by a first radiation device onto a surface to be inspected at a first predetermined irradiation angle and wherein a color image recording device records a spatially resolved image of the surface irradiated by the irradiation direction at a first observation angle, wherein this image recording device (4) having a first predetermined sensitivity dependent on a wavelength of the radiation impinging on the image recording device, wherein an image evaluation device carries out a section-by-section evaluation of the image recorded up by the image recording device.

2. The method according to claim 1, wherein the evaluation is carried out as a function of the wavelength of the radiation impinging on the image recording device and/or as a function of a wavelength-dependent sensitivity of the image recording device.

3. The method according to claim 2, wherein a wavelength-dependent sensitivity of the image recording device is determined.

4. The method according to claim 1, wherein results of the evaluation carried out by the image evaluation device are used and/or taken into account for measurements, determined and/or generated by the evaluation of a filter device which is taken into account or used for measurements.

5. The method according to claim 1, wherein the color image recording device is also used for evaluating and/or assessing the effect pigments, and/or the influence of effect pigments on the image recording and/or the integral color measurement is taken into account and/or eliminated within the scope of the image evaluation.

6. The method according to claim 2, wherein the wavelength-dependent sensitivity of the image recording device is determined by a spectrometer and/or a monochromator and/or the evaluation of the image recorded by the image recording device is carried out by a spectrometer and/or a monochromator.

7. The method according to claim 2, wherein for determining the wavelength-dependent sensitivity of the image recording device, radiation is irradiated onto the surface at a predetermined angle onto a set of reference surfaces with known reflectance.

8. The method according to claim 1, wherein the evaluation takes into account a sensitivity of the human eye which is dependent on a wavelength of the radiation incident on the human eye.

9. The method according to claim 1, wherein radiation is irradiated onto the surface by a second radiation device at a second predetermined irradiation angle and the image recording device records an image of the surface irradiated by the second radiation device.

10. The method according to claim 4, wherein the filter device takes into account an emission spectrum of the radiation device, an intensity curve of a standard light, at least one tristimulus function and/or one for a filter characteristic of the image recording device.

11. The method according to claim 1, wherein the angle of observation with respect to a direction perpendicular to the surface is smaller than 10° and/or in that the first angle of incidence with respect to a direction perpendicular to the surface is between 70° and 20°.

12. A method according to claim 1, wherein a data reduction of the data recorded in the course of the evaluation is carried out.

13. An apparatus for inspecting lacquered surfaces, one or more layers with absorption pigments and/or effect pigments, having a first radiation device which irradiates radiation onto a surface to be inspected at a first predetermined irradiation angle, and having a color image recording device which records a spatially resolved image of the surface irradiated by the irradiation direction at a first observation angle, wherein this image recording device having a first predetermined sensitivity which is dependent on a wavelength of the radiation impinging on the image recording device, wherein the apparatus has an image evaluation device which carries out a section-by-section evaluation of the image recorded by the image recording device.

14. The apparatus according to claim 13, wherein the apparatus has a filter device which calibrates further images recorded by the image recording device and calibrates them taking into account the values determined by the evaluation device and/or which is suitable and intended for this purpose.

15. The apparatus according to claim 13, wherein the filter device performs a pixel-by-pixel calibration of the values or signals output by the individual pixels of the color image recording device.
